(19) United States
(12) Patent Application Publication
(10) Pub. No.: US 2015/0370482 A1
(43) Pub. Date: Dec. 24, 2015

(54) STORAGE APPARATUS, COMMUNICATION APPARATUS, AND STORAGE CONTROL SYSTEM

(71) Applicant: KABUSHIKI KAISHA TOSHIBA, Tokyo (JP)

(72) Inventors: Daisuke MITO, Kawasaki Kanagawa (JP); Teruji YAMAKAWA, Chuo Tokyo (JP); Kentaro UMESAWA, Kawasaki Kanagawa (JP)

(21) Appl. No.: 14/624,502

(22) Filed: Feb. 17, 2015

(30) Foreign Application Priority Data
Jun. 20, 2014 (JP) 2014-127741

(51) Int. Cl. G06F 3/06

(52) U.S. Cl. CPC G06F 3/0604; G06F 3/0653; G06F 3/0673

(57) ABSTRACT

A storage apparatus includes a storage unit having plural regions including a first region and a second region, an interface unit configured to receive from an external device an access request for access to the first region, and a controller configured to control the storage unit to store in the second region information indicating that the access request has been received and executed.

### CROSS-REFERENCE TO RELATED APPLICATION

This application is based upon and claims the benefit of priority from Japanese Patent Application No. 2014-127741, filed Jun. 20, 2014, the entire contents of which are incorporated herein by reference.

### FIELD

Embodiments described herein relate generally to a storage apparatus, a communication apparatus, and a storage control system.

### BACKGROUND

In the related art, a storage apparatus such as a hard disk drive (HDD) or a Solid State Drive (SSD) is used in various circumstances for storing information. Recently, a technique for improving security of information stored in the storage apparatus is proposed. According to the technique, an information processing apparatus connected to a storage apparatus generates an access log indicating an access to the storage apparatus and monitor an unauthorized access to the storage apparatus by referring to the access log.

However, as the access log is managed by the information processing apparatus, the access log may be falsified by a user accessing the information processing apparatus without authorization. Therefore, the access log may not always reflect unauthorized accesses.

### DESCRIPTION OF THE DRAWINGS

FIG. 1 illustrates a data managing system according to an embodiment.

FIG. 2 is a block diagram of a storage apparatus included in the data managing system according to the embodiment.

FIG. 3 illustrates a structure of a specific area management table according to the embodiment.

FIG. 4 illustrates an example of a log stored in a log storing unit according to the embodiment.

FIG. 5 is a sequence diagram of a process for setting a specific area in the storage apparatus.

FIG. 6 is a flow chart of a process carried out when the specific area is set in the storage apparatus.

FIG. 7 is a sequence diagram of a process when a read/write instruction is received by the storage apparatus.

FIG. 8 is a flow chart of a control process carried out in the storage apparatus.

FIG. 9 is a sequence diagram of a process when the log is acquired from the storage apparatus.

FIG. 10 is a flow chart of a process carried out when the log is output by the storage apparatus.

### DETAILED DESCRIPTION

An embodiment provides a storage apparatus in which security is improved.

In general, according to one embodiment, a storage apparatus includes a storage unit having plural regions including a first region and a second region, an interface unit configured to receive from an external device an access request for access to the first region, and a controller configured to control the storage unit to store in the second region information indicating that the access request has been received and executed.

A storage apparatus and a storage system according to the embodiment are described with reference to the accompanying drawings. Further, the configuration is not limited to the embodiments.

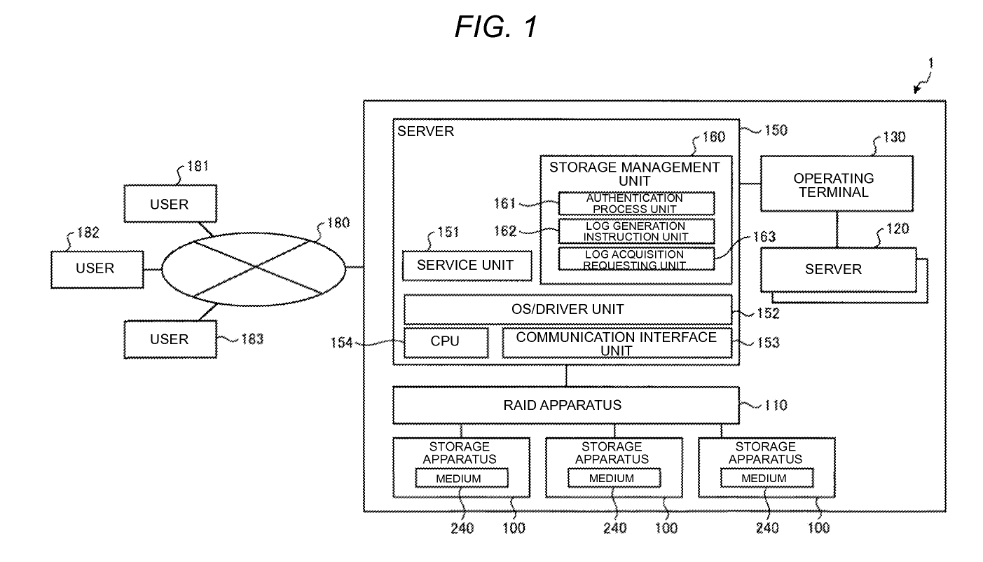

FIG. 1 illustrates a data managing system according to an embodiment. The data managing system illustrated in FIG. 1 has a data center 1 in order to respond to a request from users 181 to 183 through a public network 180.

The data center 1 includes a server 150, other servers 120, a RAID apparatus 110, a plurality of storage apparatuses 100, and an operator terminal 130.

The RAID apparatus 110 performs duplication or acceleration (stripping) of data stored in the plurality of storage apparatuses 100 in order to protect data of the plurality of storage apparatuses 100. Further, instructions for reading and writing data are transmitted to the plurality of storage apparatuses 100 according to the request from the users 181 to 183 through the server 150.

The server 150 accesses the plurality of storage apparatuses 100 connected to the RAID apparatus 110 according to the request from the operator terminal 130. Further, in an example of FIG. 1, although three of the storage apparatuses 100 are connected to the RAID apparatus 110, the number of connected storage apparatuses 100 is not limited thereto. In addition, the other server 120 has the same configuration as the server 150, and is connected to respective storage apparatuses in the same manner. The description of the storage apparatuses connected to the other server 120 is omitted.

The server 150 includes a communication interface unit 153 and a CPU 154.

The CPU 154 is a controller that controls the entire server 150, and configures a service unit 151, an OS/driver unit 152, and storage management unit 160 by executing various programs stored in a nonvolatile memory (not illustrated).

The service unit 151 is configured by executing an application group for providing a service to the users 181 to 183 connected through the public network 180.

The OS/driver unit 152 is configured by executing a software group including an operating system (OS) for controlling the server 150, and drivers or the like for causing the operating system to control hardware provided in the server 150. The service unit 151 and the storage management unit 160 may receive and transmit data or instructions to other apparatuses (for example, the RAID apparatus 110) by the execution of the software group corresponding to the OS/driver unit 152.

The communication interface unit 153 is an interface for transmitting and receiving data to and from other apparatuses (for example, the RAID apparatus 110). In addition, the communication interface unit 153 communicates with the storage apparatuses 100 through the RAID apparatus 110. Accordingly, the server 150 may communicate with the storage apparatuses 100.

The storage management unit 160 is a unit for managing data stored in the storage apparatuses 100 through the RAID apparatus 110, and includes an authentication process unit 161, a log generation instructing unit 162, and a log acquisition requesting unit 163. In addition, the storage management unit 160 performs various instructions to the storage apparatuses 100 according to the request from the operator terminal 130.

The authentication process unit 161 requests authentication to access the storage apparatuses 100 to generate logs, or to acquire logs.

The log generation instructing unit 162 transmits area setting instructions to the storage apparatuses 100 through the communication interface unit 153 according to the instructions from the operator terminal 130 when the authentication process unit 161 obtains the authentication. The area setting instructions are instructions to set areas in storage media 240 included in the storage apparatuses 100, as log generation targets. After the log generation instructing unit 162 transmits the area setting instructions to the storage apparatuses 100, if the user 180 attempt to access the areas set according to the area setting instruction, the access history is generated and stored in a log.

When the authentication process unit 161 succeeds in obtaining the authentication from the storage apparatuses 100, the log acquisition requesting unit 163 transmits to the storage apparatuses 100 a request for outputting a log stored in the storage media 240 thereof through the communication interface unit 153 according to the instruction from the operator terminal 130. Then, the log acquisition requesting unit 163 transmits the logs transmitted from the storage apparatuses 100 to the operator terminal 130. Accordingly, the operator may check an access performed on a specific area of the storage apparatus 100 through the operator terminal 130.

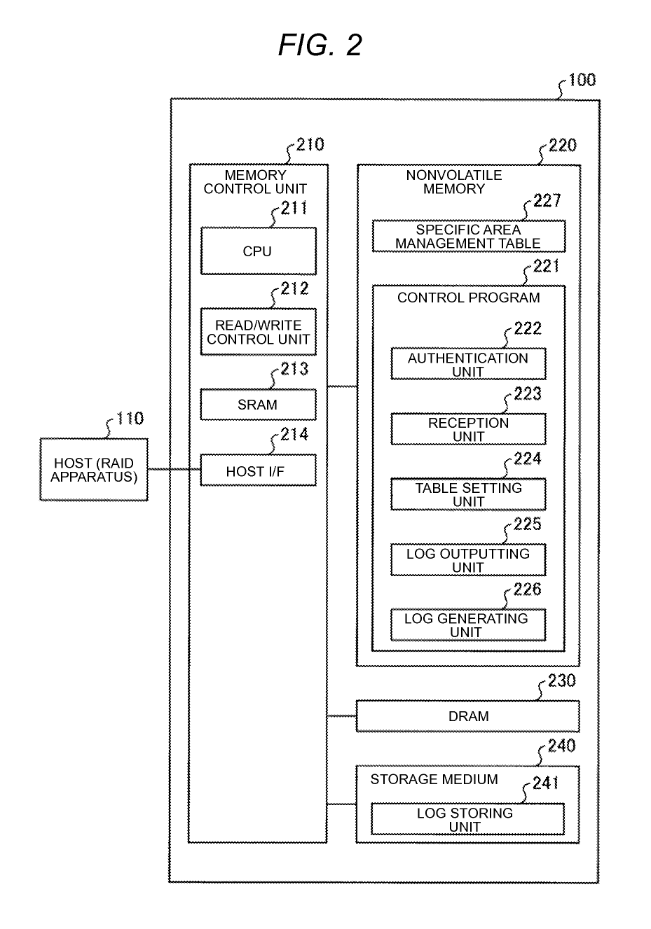

Next, the configuration of the storage apparatus 100 is described. FIG. 2 is a block diagram of the storage apparatus 100 according to the embodiment. As illustrated in FIG. 2, the storage apparatus 100 includes a memory control unit 210, a nonvolatile memory 220, a DRAM 230, and the storage medium 240. The storage apparatus 100 according to the embodiment may be a hard disk drive, or an apparatus such as a Solid State Drive (SSD) that can read and write data. For example, if the storage apparatus 100 is a hard disk drive, the storage medium 240 is a magnetic disk, and if the storage apparatus 100 is an SSD, the storage medium 240 is a semiconductor memory.

The DRAM 230 is a volatile storage area, and when a CPU 211 of the memory control unit 210 performs a process, the DRAM 230 is used as a work area.

The memory control unit 210 includes the CPU 211, a read/write control unit 212, an SRAM 213, and a host I/F 214.

The host I/F 214 functions as an interface unit for communicating with a communication apparatus (for example, the server 150 or the RAID apparatus 110), with respect to the access to the storage medium 240. For example, the host I/F 214 performs a process according to an interface standard with respect to a host 110, and receives instructions or data from the host 110. In addition, the host I/F 214 transmits the data read from the storage medium 240, the response from the CPU 211, and the like, to the host 110.

Here, the host that is connected to the storage apparatus 100 and transmits read instructions or write instructions is the RAID apparatus 110, but the host is not limited to the RAID apparatus 110, and may be a PC, a tablet terminal, or the like.

The Static Random Access Memory (SRAM) 213 temporarily stores data received by the memory control unit 210 from the host 110 until the data is stored in the storage medium 240. In addition, the SRAM 213 temporarily stores the data read from the storage medium 240 until the data is transmitted to the host 110. Here, the SRAM 213 is used for a data buffer, but other memories such as a DRAM may be used for the data buffer.

The read/write control unit 212 writes data in the storage medium 240 based on the instruction of the CPU 211 (for example, a control program 221 executed by the CPU 211). In addition, the read/write control unit 212 reads data from the storage medium 240 based on the instruction of the CPU 211.

The CPU 211 functions as a controller that controls the entire storage apparatus 100. For example, the CPU 211 controls the writing of the data in the storage medium 240 through the read/write control unit 212, and the reading of data from the storage medium 240.

The nonvolatile memory 220 is a readable and writable memory that may maintain the storage even if the power is not supplied, and includes the control program 221 and a specific area management table 227.

The control program 221 includes various modules to configure the CPU 211 to function as an authentication unit 222, a reception unit 223, a table setting unit 224, a log outputting unit 225, and a log generating unit 226. When the storage apparatus 100 is turned on, the CPU 211 reads the control program 221 so that it is configured according to respective modules the control program 221 and performs processes as the controller that controls the entire storage apparatus 100, and also as the authentication unit 222, the reception unit 223, the table setting unit 224, the log outputting unit 225, and the log generating unit 226.

The authentication unit 222 authenticates the communication apparatus (for example, the server 150).

After the authentication unit 222 authenticates the communication apparatus, the reception unit 223 receives an instruction from the communication apparatus (for example, the server 150) through the host 110 and the host I/F 214. The received instruction may be an area setting instruction for setting an area in the storage medium 240 as a log generation target, a log output instruction that requests an output of the log, or the like.

When the reception unit 223 receives the area setting instruction, the table setting unit 224 sets and updates the specific area management table 227 in order to store the access to the area set as the log generation target by the area setting instruction, as a log.

The specific area management table 227 is a table provided on the storage medium 240 for managing a specific area. The specific area is a target area among storage areas in the storage medium 240 and accesses to the specific area are recorded in a log.

That is, in the storage medium 240 of the storage apparatus 100 according to the embodiment, when an access to an area storing important data is set as the specific area, information related to the access to the specific area can be stored as the log. Accordingly, it is possible to record the access to the important data. Further, it is possible to improve security of information stored in the specific area by giving the authority to set the specific area only to the operator who has an administrator authority, or the like, using the specific area management table 227.

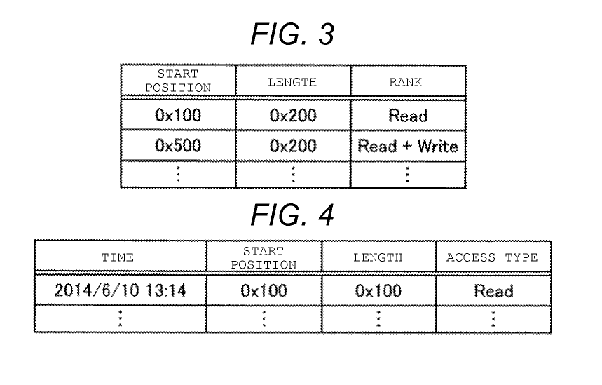

FIG. 3 illustrates a structure of the specific area management table 227. As illustrated in FIG. 3, the specific area management table 227 includes a starting position, a length (block), and a rank associated with each other. The starting position according to the embodiment is a starting position of the specific area, and indicated by a logical address (LBA) for specifying a data storage area in the storage media 240. The length indicates the LBA length (the number of blocks) for specifying the scope of the specific area.

The rank is information for specifying the kind of the processes to be recorded as the log of the specific area. For example, when the rank is “Read”, if the read process is executed according to the read instruction with respect to the specific area, an input to the log is performed. When the rank is “Read+Write”, if the process corresponding to any of the read instruction and the write instruction with respect to the specific area is executed, an input to the log is performed.

According to the embodiment, it is possible to appropriately store the log according to the importance of the data stored in the area, by individually (independently) setting ranks for each specific area.

The starting positions, the lengths, and the ranks are included in the area setting instruction from the storage management unit 160. According to the embodiment, logs of the plurality of areas may be recorded by registering the plurality of specific areas in the specific area management table 227. In other words, the starting positions, the lengths, and the ranks registered in the specific area management table 227 are designated by the area setting instruction.

In addition, in the storage apparatus 100 according to the embodiment, the log generating unit 226 may generate the instruction performed on the specific area management table 227 (for example, area setting instructions or the like), as the log.

Returning to FIG. 2, if the memory control unit 210 receives the read/write instruction of the data from the host 110, the CPU 211 (the log generating unit 226) determines whether an access destination according to the read/write instruction is registered in the specific area management table 227. Then, if it is determined that the access destination according to the read/write instruction is registered in the specific area management table 227, the CPU 211 (the log generating unit 226) controls the read/write control unit 212 so that the information relating to the read/write instruction is recorded as a history to the log stored in a log storing unit 241.

Accordingly, if there is an access to the area in the storage media 240 that is set as the specific area according to the area setting instruction received by the reception unit 223, it is possible to generate the log indicating the access. Additionally, when the information is written to the log, the CPU 211 (the log generating unit 226) provides the electronic signature to the generated log.

In addition, the log generating unit 226 generates logs in response to a type of access corresponding to the rank of the area. For example, in the specific area management table 227, when the rank of the area stored in the storage medium 240 is “Read”, the log generating unit 226 generates the log with respect to the access as the history only when the read instruction is received. In addition, when the rank of the area is “Read+Write”, the log generating unit 226 generates the log with respect to the access as the history when the read instruction or the write instruction is received.

Further, when a certain access (Read) to the area is performed, the log generating unit 226 generates a log indicating that the access (Read) is performed, according to the rank “Read”. When the access (Write), which is the kind different from the access (Read), is performed to the area, the log generating unit 226 generates a log indicating that the access (Write) is performed, according to the rank “Read+Write”.

The storage medium 240 stores data transmitted from the host 110 in a nonvolatile manner. In the storage apparatus 100 according to the embodiment, it is possible to set whether to generate the log in units of the area of the storage medium 240. The storage medium 240 includes the log storing unit 241 for storing the generated log. The log storing unit 241 may be provided on any area on the storage medium 240.

FIG. 4 illustrates a log stored in the log storing unit 241 according to the embodiment. As illustrated in FIG. 4, the log is stored in association with time, a starting position, a length, and a kind of access.

When the reception unit 223 receives a log output instruction requesting an output of a log of a certain specific area from a communication apparatus (for example, the host 110), the log outputting unit 225 outputs the log generated by the log generating unit 226 according to the received log output instruction, to the communication apparatus.

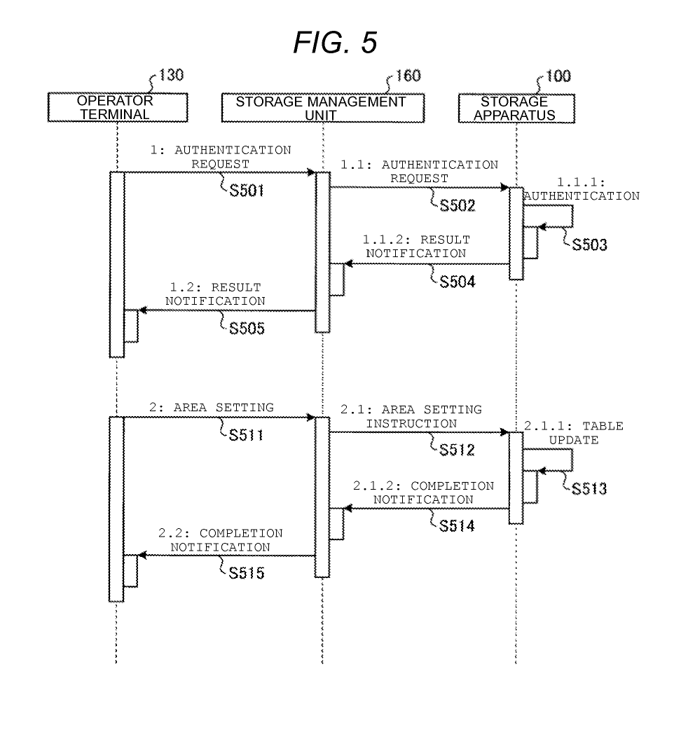

FIG. 5 is a sequence diagram of a process for setting the specific area in the storage apparatus 100 of the data managing system according to the embodiment. The operator terminal 130 according to the embodiment may use the storage management unit 160 in the server 150, by transmitting or receiving data to and from the server 150.

First, the operator terminal 130 sends the authentication request to the storage management unit 160 of the server 150 (Step S501). Any kind of method may be used as the authentication method, but a method of using, for example, an authentication PIN (Personal Identification Number) may be used.

When the authentication request is received from the operator terminal 130, the authentication process unit 161 of the storage management unit 160 transmits an authentication request together with the authentication PIN to the storage apparatus 100 (Step S502). Further, as a method for specifying the storage apparatus 100, which is an authentication destination, any kind of method may be used. For example, when the data for which the log should be generated is instructed from the operator terminal 130, the storage apparatus 100 storing the data may be specified as the authentication destination.

Then, when the reception unit 223 of the storage apparatus 100 receives the authentication request, the authentication unit 222 authenticates the operator by using the received authentication PIN (Step S503).

Thereafter, the authentication unit 222 of the storage apparatus 100 transmits the authentication result to the storage management unit 160 (Step S504). Then, the storage management unit 160 transmits the authentication result to the operator terminal 130 (Step S505). Accordingly, the operator terminal 130 (or the operator using the operator terminal 130) can recognize whether the authentication unit 222 authenticated the operator terminal 130. Then, if the authentication unit 222 authenticated the operator terminal 130, the following processes are performed.

The operator terminal 130 sets the specific area in the storage media 240 of the storage apparatus 100 to be a target for generating the log by using the log generation instructing unit 162 of the storage management unit 160 (Step S511). As the setting method, for example, in the area of the storage medium 240 of the storage apparatus 100, the area in which data of great importance is stored may be designated.

Then, the log generation instructing unit 162 transmits the area setting instruction for setting the specific area received from the operator terminal 130 to be a log generation target, to the storage apparatus 100 (Step S512).

When the reception unit 223 of the storage apparatus 100 receives the area setting instruction, the table setting unit 224 adds information for setting the area as the specific area to the specific area management table 227 and updates the specific area management table 227 (Step S513). Further, when there is no specific area management table, the specific area management table 227 may be generated.

Then, the table setting unit 224 transmits the completion notification of the addition of the specific area, to the storage management unit 160 of the server 150 (Step S514). Thereafter, the storage management unit 160 transmits the completion notification to the operator terminal 130 (Step S515).

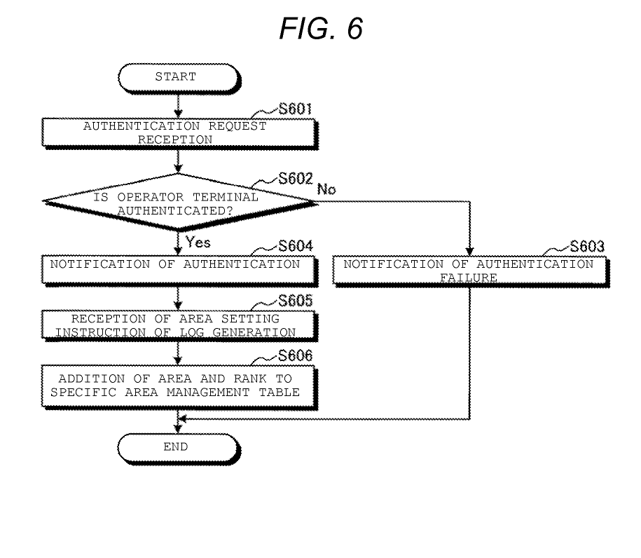

Next, a process carried out when the specific area is set in the storage apparatus 100 is described. FIG. 6 is a flow chart of the aforementioned sequence carried out by the storage apparatus 100.

First, the reception unit 223 receives the authentication request from the server 150 (Step S601). At this point, the reception unit 223 receives PIN or the like together with the authentication request. Next, the authentication unit 222 performs the authentication process based on the received PIN or the like, and determines whether the authentication unit 222 authenticates the operator terminal 130 (Step S602). If the authentication is failed (Step S602: No), the authentication unit 222 notifies the server 150 of the failure of the authentication (Step S603), and ends the process.

Meanwhile, when it is determined that the authentication unit 222 authenticates the operator terminal 130 (Step S602: Yes), the server 150 is notified of the authentication (Step S604).

Thereafter, the reception unit 223 receives the area setting instruction for setting the area to be an access monitoring target (to be the log generation target) (Step S605).

Then, the table setting unit 224 adds the area and the rank indicated in the area setting instruction to the specific area management table 227 (Step S606).

According to the aforementioned process sequence, any area of the storage media 240 of the storage apparatus 100 can be set as the specific area, based on the operation from the operator terminal 130 of the server 150.

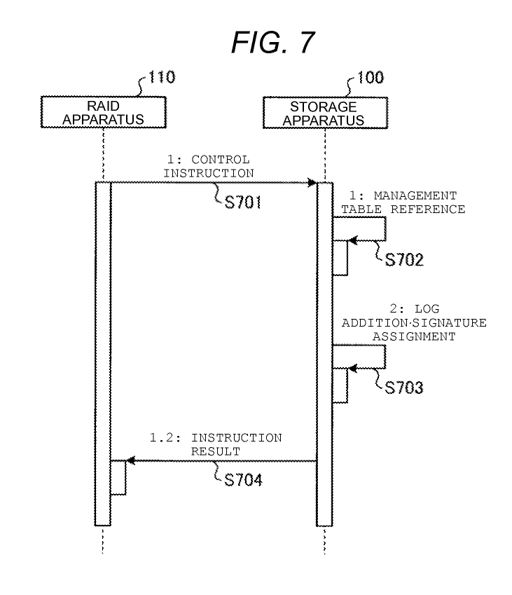

FIG. 7 is a sequence diagram of the process when a read/write instruction is received by the storage apparatus 100 of the data managing system according to the embodiment.

First, the host 110 transmits to the storage apparatus 100 a control instruction (for example, a read instruction, a write instruction, an erase instruction, or a format instruction) with respect to the storage medium 240 (Step S701). Next, the log generating unit 226 of the storage apparatus 100 refers to the specific area management table 227 and determines whether the access destination of the control instruction is the specific area, and whether the control instruction is the recording target on the log based on the rank (Step S702). The sequence diagram of FIG. 7 describes a case in which the access destination is the specific area and the received control instruction is the recording target.

Then, as the process is performed according to the received control instruction, the CPU 211 (the log generating unit 226) adds the history relating to the received control instruction to the log and provides the electronic signature to the log (Step S703).

Then, the memory control unit 210 transmits to the host 110 the result of the control instruction with respect to the storage medium 240 by the read/write control unit 212 (Step S704).

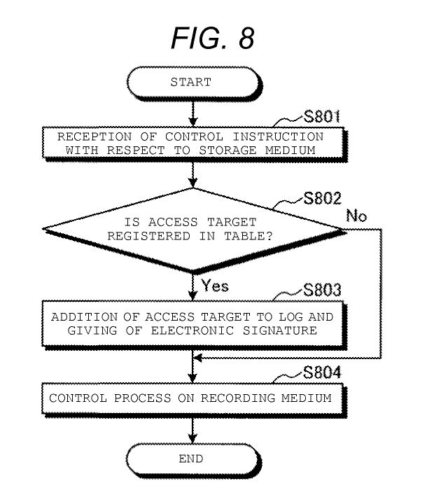

Next, a process carried out when the access is recorded in the log by the storage apparatus 100 is described. FIG. 8 is a flow chart of the aforementioned sequence carried out by the storage apparatus 100.

First, the memory control unit 210 receives the control instruction (for example, the read instruction, the write instruction, the erase instruction, or the format instruction) with respect to the storage medium 240 from the host 110 (Step S801). Then, the log generating unit 226 determines whether the access destination of the control instruction is registered in the specific area management table 227 (Step S802). Further, the log generating unit 226 determines whether the rank corresponds to the received control instruction.

Then, if the log generating unit 226 determines that the access destination of the control instruction is not registered in the specific area management table 227 or the rank does not correspond to the received control instruction (Step S802: No), the process goes to Step S804.

Meanwhile, if the log generating unit 226 determines that the access destination of the control instruction is registered in the specific area management table 227 and the received control instruction and the rank corresponds to each other (Step S802: Yes), the CPU 211 (the log generating unit 226) controls the read/write control unit 212 to add the time when the control instruction is performed, the access destination, the performed control (reading, writing, erasing, or formatting) in an associated manner as the log, and to provide the electronic signature (Step S803).

Thereafter, the read/write control unit 212 performs control (reading, writing, erasing, or formatting) with respect to the storage medium 240 according to the received control instruction (Step S804).

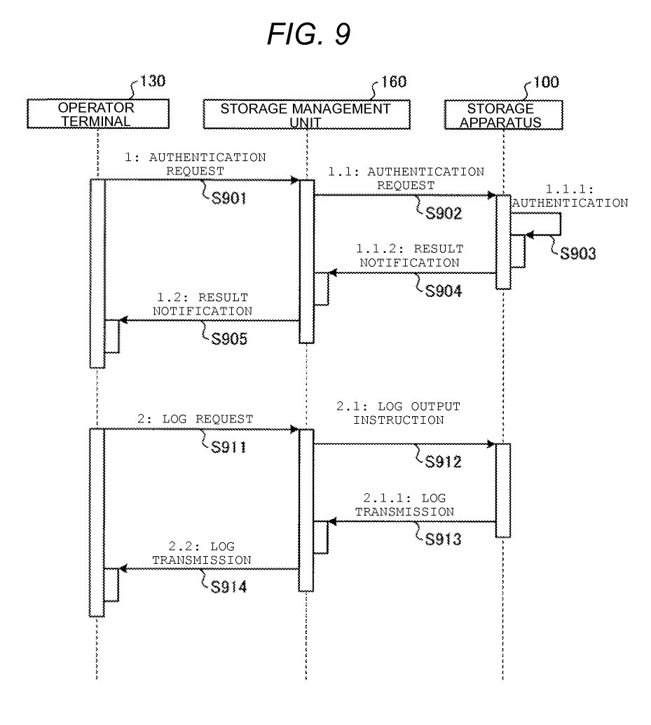

FIG. 9 is a sequence diagram of the process when the log is obtained from the storage apparatus 100 of the data managing system according to the embodiment.

First, the operator terminal 130 performs an authentication request to the storage management unit 160 of the server 150 connected to the operator terminal 130 by using an authentication PIN (Personal Identification Number) or the like (Step S901).

When the authentication process unit 161 of the storage management unit 160 receives the authentication request from the operator terminal 130, the authentication request is transmitted to the storage apparatus 100, together with the authentication PIN (Step S902). For example, according to the embodiment, the storage management unit 160 may maintain information about a storage apparatus and a logical address in which data requested by the operator is stored, and specify the storage apparatus 100 and the specific area (starting position and length) from which the log is obtained, when the log output instruction requesting output of the log relating to the data to be checked is received.

Then, when the reception unit 223 of the storage apparatus 100 receives the authentication request, the authentication unit 222 authenticates the operator by using the received authentication PIN (Step S903).

Thereafter, the authentication unit 222 of the storage apparatus 100 notifies the storage management unit 160 of the authentication result (Step S904). Then, the storage management unit 160 notifies the operator terminal 130 of the authentication result (Step S905). Accordingly, the operator who uses the operator terminal 130 recognizes whether the authentication unit 222 authenticated the operator terminal 130. Then, when the authentication unit 222 authenticated the operator terminal 130, the following processes are performed.

The operator terminal 130 performs the acquisition request of the log relating to the specific area of the storage medium 240 of the storage apparatus 100 by using the log acquisition requesting unit 163 of the storage management unit 160 (Step S911).

Then, the log acquisition requesting unit 163 transmits the log output instruction of the specific area (the starting position and the length) received from the operator terminal 130 to the storage apparatus 100 (Step S912).

When the reception unit 223 of the storage apparatus 100 receives the log output instruction of the specific area (the starting position and the length), the log outputting unit 225 reads the corresponding log from the log storing unit 241, and transmits the log to the storage management unit 160 (Step S913). Thereafter, the storage management unit 160 transmits the log to the operator terminal 130 (Step S914).

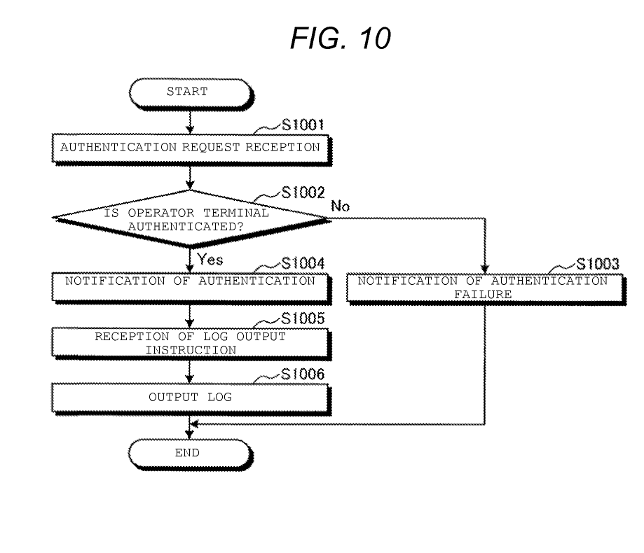

Next, a process carried out when the log is output from the storage apparatus 100 is described. FIG. 10 is a flowchart of the aforementioned sequence carried out by the storage apparatus 100.

First, the reception unit 223 receives the authentication request from the server 150 (Step S1001). At this point, the reception unit 223 receives the PIN or the like together with the authentication request. Next, the authentication unit 222 performs the authentication based on the received PIN or the like, and determines whether the authentication unit 222 authenticates the operator terminal 130 (Step S1002). If it is determined that the authentication unit 222 does not authenticates the operator terminal 130 (Step S1002: No), the authentication unit 222 notifies the server 150 of the failure of the authentication (Step S1003), and ends the process.

Meanwhile, if it is determined that the authentication unit 222 authenticates the operator terminal 130 (Step S1002: Yes), the authentication unit 222 notifies the server 150 of the authentication (Step S1004).

Thereafter, the reception unit 223 receives the specific area (the starting position and the length) as the output target of the log, together with the log output instruction (Step S1005).

Then, the log outputting unit 225 obtains the log relating to the received specific area from the log storing unit 241, and outputs the log to the server 150 (Step S1006).

According to the aforementioned process, since the desired log is given to the operator terminal 130 from the server 150, the operator may check what kind of access was performed with respect to the specific area.

Conventionally, a technique of constructing a system managing an access history of a storage apparatus is proposed in the related art. The system manages a log of a storage apparatus in an information processing apparatus of a server or the like connected to the storage apparatus. In this case, when the system is accessed or attacked by a malicious third party without authorization, the unauthorized access history remains in the system log of the OS or the like. The administrator of the system may analyze the unauthorized access history, but the system log may be falsified by the unauthorized user. If the system log is falsified, whether there is an unauthorized access cannot be not found. Therefore, it is desirable that the log is managed on a lower layer of the system so that the system log is not falsified. Here, according to the aforementioned embodiment, history of the access performed with respect to the specific area is managed in the single storage apparatus 100.

In the storage apparatus 100, when the read/write instruction is performed on an area, an interface (for example, a command or an API) for storing the log relating to the instruction and an interface (for example, a command or an API) for acquiring the log are prepared. However, as an interface for rewriting the log is not provided in the storage apparatus 100, even if the system is accessed by the malicious third party without authorization, the log may not be rewritten. Therefore, the security may be improved.

Additionally, according to the aforementioned embodiment, an access not to the entire storage medium 240, but to a specific area of the storage medium 240, is managed as a log. Accordingly, data amount of the log is not too large, and too many area of the storage medium 240 is not occupied with the log.

According to the embodiment, the authentication is performed when the specific area is set or the log is output. Accordingly, since the specific area may be set or the log may be referred only by the operator with authorization, it is possible to heighten the security. Additionally, since the access history performed on important information may be referred by the operator, by setting the area in which the important information is stored as the specific area, it is possible to check whether the unauthorized access to the important information is performed.

It is possible to increase the reliability of the analysis of the unauthorized access and to improve the security by securely storing the access log to the important data in the storage apparatus. In the storage apparatus according to the embodiment, since the access performed in units of the area can be stored as the log, it is possible to improve the security.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a storage unit having plural regions including a first region and a second region;
an interface unit configured to receive from an external device an access request for access to the first region; and
a controller configured to control the storage unit to store in the second region information indicating that the access request has been received and executed.

2. The storage apparatus according to claim 1, wherein
the interface unit is further configured to receive a region setting request for setting of one or more of the plural regions as the first region, and
the controller is further configured to set the regions indicated by the region setting request as the first region.

3. The storage apparatus according to claim 2, wherein
the interface unit is further configured to receive an identification information of a user who causes the region setting request to be sent to the storage apparatus, and
the controller is further configured to authenticate the identification information and set the regions indicated by the region setting request as the first region when the identification information is authenticated.

4. The storage apparatus according to claim 1, wherein the controller is further configured to store in a management table information indicating that the regions indicated by the region setting request is the first region.

5. The storage apparatus according to claim 1, wherein
the access to the first region includes plural types of access,
the interface unit is further configured to receive a type setting request for setting of a type of access that triggers the storing of the information in the second region, and
the controller is configured to control the storage unit to store the information in the second region when the type of access requested in the access request is the type of access indicated by the type setting request.

6. The storage apparatus according to claim 5, wherein the plural types of access include writing of data into the first region and reading of data from the first region.

7. The storage apparatus according to claim 1, wherein the controller is further configured to generate an electronic signature with respect to the information stored in the second region.

8. The storage apparatus according to claim 1, wherein
the interface unit is further configured to receive an output request for output of the information stored in the second region, and
the controller is further configured to output the information upon the receiving the output request.

9. A communication apparatus comprising:
an interface unit configured to communicate with a storage apparatus including a storage unit having plural regions including a first region and a second region, a first interface unit configured to receive from an external device an access request for access to the first region, and a controller configured to control the storage unit to store in the second region information indicating that the access request has been received and executed; and
a storage management unit configured to output to the storage apparatus through the interface unit, a region setting request for setting of one or more of the plural regions as the first region.

10. The communication apparatus according to claim 9, wherein the storage management unit is further configured to output to the storage apparatus through the interface unit, an authentication request to access the storage apparatus.

11. The communication apparatus according to claim 10, wherein the authentication request includes an identification information of a user who causes the region setting request to be output to the storage apparatus.

12. The communication apparatus according to claim 9, wherein the controller is configured to store in a management table information indicating that the regions indicated by the region setting request is the first region.

13. The communication apparatus according to claim 9, wherein
the access to the first region includes plural types of access, and
the storage management unit is further configured to output a type setting request for setting of a type of access that triggers the storing of the information in the second region, and
the controller is configured to control the storage unit to store the information in the second region when the type of access requested in the access request is the type of access indicated by the type setting request.

14. The communication apparatus according to claim 13, wherein the plural types of access include writing of data into the first region and reading of data from the first region.

15. The communication apparatus according to claim 9, wherein the controller is further configured to generate an electronic signature with respect to the information stored in the second region.

16. The communication apparatus according to claim 9, wherein
the storage management unit is further configured to output a request for output of the information stored in the second region, and
the controller is further configured to output the information upon the receiving the output request.

17. A storage system comprising:
a storage apparatus including a storage unit having plural regions including a first region and a second region, a first interface unit configured to receive from an external device an access request for access to the first region, and a controller configured to control the storage unit to store in the second region information indicating that the access request has been received and executed; and
a communication apparatus including a second interface unit configured to transmit to the first interface unit a region setting request for setting of one or more of the plural regions as the first region,
wherein the controller is further configured to set the regions indicated by the region setting request as the first region.

18. The storage system according to claim 17, wherein
the second interface unit is further configured to transmit to the first interface unit an identification information of a user who causes the setting request to be transmitted to the storage apparatus, and
the controller is further configured to authenticate the identification information and set the regions indicated by the region setting request as the first region when the identification information is authenticated.

19. The storage system according to claim 17, wherein
the access to the first region includes plural types of access,
the second interface unit is further configured to transmit to the first interface unit a type setting request for setting of a type of access that triggers the storing of the information in the second region, and
the controller controls the storage unit to store the information in the second region when the type of access requested by the access request is the type of access indicated by the type setting request.

20. The storage system according to claim 17, wherein
the second interface unit is further configured to transmit to the first interface unit an output request for output of the information stored in the second region to the communication apparatus, and
the controller is further configured to output the information to the communication apparatus upon the receiving the output request.
